(19) United States
(12) Patent Application Publication
(10) Pub. No.: US 2018/0129500 A1
(43) Pub. Date: May 10, 2018

(54) Single-thread processing of multiple code regions

(71) Applicant: Centipede Semi Ltd., Netanya (IL)

(72) Inventors: Shay Koren, Tel-Aviv (IL); Noam Mizrahi, Hod Hasharon (IL); Jonathan Friedmann, Even Yehuda (IL)

(21) Appl. No.: 15/616,970

(22) Filed: Jun. 8, 2017

Related U.S. Application Data
(60) Provisional application No. 62/418,203, filed on Nov. 6, 2016.

(51) Int. Cl. G06F 9/30; G06F 9/38

(52) U.S. Cl. CPC G06F 9/30058; G06F 9/3855; G06F 9/3806; G06F 9/30065; G06F 9/3016; G06F 9/30105

(57) ABSTRACT

A method includes retrieving to a pipeline of a processor first instructions of program code from a first region in the program code. Before fully determining a flow-control path, which is to be traversed within the first region until exit from the first region, a beginning of a second region in the code that is to be processed following the first region is predicted, and second instructions begin to be retrieved to the pipeline from the second region. The retrieved first instructions and second instructions are processed by the pipeline.

### CROSS-REFERENCE TO RELATED APPLICATIONS

This application claims the benefit of U.S. Provisional Patent Application 62/418,203, filed Nov. 6, 2016, whose disclosure is incorporated herein by reference.

### FIELD OF THE INVENTION

The present invention relates generally to processor design, and particularly to methods and systems for run-time code parallelization.

### BACKGROUND OF THE INVENTION

Various techniques have been proposed for dynamically parallelizing software code at run-time. For example, Marcuellu et al., describe a processor microarchitecture that simultaneously executes multiple threads of control obtained from a single program by means of control speculation techniques that do not require compiler or user support, in “Speculative Multithreaded Processors,” Proceedings of the 12^{th} International Conference on Supercomputing, 1998.

Speculative processing is often based on predicting the outcome of conditional branch instructions. Various branch prediction schemes are known in the art. For example, Porter and Tullsen describe a branch prediction scheme that performs artificial modifications to a global history register to improve branch prediction accuracy, targeting regions with limited branch correlation, in “Creating Artificial Global History to Improve Branch Prediction Accuracy,” Proceedings of the 23^{rd} International Conference on Supercomputing (ICS), Yorktown Heights, N.Y., Jun. 8-12, 2009, pages 266-275.

As another example, Choi et al. describe a technique for improving branch prediction in short threads by setting the global history register of a spawned thread to the initial value of the program counter, in “Accurate Branch Prediction for Short Threads,” Proceedings of the 13^{th} ACM International Conference on Architectural Support for Programming Languages and Operating Systems (ASPLOS), Seattle, Wash., Mar. 1-5, 2008.

### SUMMARY OF THE INVENTION

An embodiment of the present invention that is described herein provides a method including retrieving to a pipeline of a processor first instructions of program code from a first region in the program code. Before fully determining a flow-control path, which is to be traversed within the first region until exit from the first region, a beginning of a second region in the code that is to be processed following the first region is predicted, and second instructions begin to be retrieved to the pipeline from the second region. The retrieved first instructions and second instructions are processed by the pipeline.

In some embodiments, processing the first instructions and the second instructions includes renaming at least one of the second instructions before all the first instructions have been renamed by the pipeline. In an example embodiment, processing the first instructions and the second instructions includes dispatching to a reorder buffer at least one of the second instructions before all the first instructions have been renamed by the pipeline. In another embodiment, processing the first instructions and the second instructions includes defining an initial architectural-to-physical register mapping for the second region before all architectural registers appearing in the first instructions have been mapped to physical registers.

In an embodiment, the first instructions belong to a program loop, and the second instructions belong to a code segment subsequent to the program loop. In another embodiment, the first instructions belong to a function, and the second instructions belong to a code segment subsequent to returning from the function.

In an embodiment, retrieving the first instructions and the second instructions includes fetching at least one instruction from a memory or cache. In an embodiment, retrieving the first instructions and the second instructions includes reading at least one decoded instruction or micro-op from a cache that caches previously-decoded instructions or micro-ops.

In another embodiment, prediction of the beginning of the second region is based on a history of past branch decisions of one or more instructions that conditionally exit the first region. In yet another embodiment, prediction of the beginning of the second region is independent of past branch decisions of branch instructions that do not exit the first region. In still another embodiment, prediction of the beginning of the second region is independent of past branch decisions of branch instructions that are in the first region. In a further embodiment, prediction of the beginning of the second region is based on historical exits from the first region, or from one or more other regions. In another embodiment, prediction of the beginning of the second region is based on one or more hints embedded in the program code.

In some embodiments, the method further includes predicting a flow control in the second region based on one or more past branch decisions of one or more instructions in the first region. In some embodiments, the method further includes predicting a flow control in the second region based on one or more past branch decisions of one or more instructions that precede the first region. In an example embodiment, prediction of the flow control in the second region is independent of past branch decisions of branch instructions that are in the first region.

In another embodiment, the method further includes predicting a flow control in the second region based on an exit point from the first region. In yet another embodiment, processing the first instructions and the second instructions includes, as long as one or more conditional branches in the first region are unresolved, executing only second instructions that do not depend on any register value set in the first region. In still another embodiment, processing the first instructions and the second instructions includes, while one or more conditional branches in the first region are unresolved, executing one or more of the second instructions that depend on a register value set in the first region, based on a prediction of the register value set in the first region.

In some embodiments, processing the first instructions and the second instructions includes making a data value, which is produced by the first instructions, available to the second instructions only in response to verifying that the data value is valid for readout by the second instructions.

There is additionally provided, in accordance with an embodiment of the present invention, a processor including a hardware-implemented pipeline and control circuitry. The control circuitry is configured to instruct the pipeline to retrieve first instructions of program code from a first region in the program code, and, before fully determining a flow-control path, which is to be traversed within the first region until exit from the first region, to predict a beginning of a second region in the code that is to be processed following the first region and instruct the pipeline to begin retrieving second instructions from the second region, so as to cause the pipeline to process the retrieved first instructions and second instructions.

The present invention will be more fully understood from the following detailed description of the embodiments thereof, taken together with the drawings in which:

### BRIEF DESCRIPTION OF THE DRAWINGS

FIGS. 1-3 are block diagrams that schematically illustrate processor architectures, in accordance with embodiments of the present invention;

FIG. 4 is a block diagram that schematically illustrates an exit predictor, respectively, in accordance with embodiments of the present invention;

FIGS. 5-7 are diagrams that schematically illustrate branch histories for use in branch prediction, in accordance with embodiments of the present invention;

FIG. 8 is a flow chart that schematically illustrates a method for processing of multiple code regions, in accordance with an embodiment of the present invention; and

FIGS. 9-12 are diagrams that schematically illustrate examples of code regions processed by the method of FIG. 8, in accordance with embodiments of the present invention.

### DETAILED DESCRIPTION OF EMBODIMENTS

### Overview

Embodiments of the present invention that are described herein provide improved methods and systems for run-time parallelization of code in a processor. In the disclosed embodiments, a processor processes a first code region having multiple possible flow-control paths. While processing the first code region, the processor determines a second code region that appears later in the code but will be processed in parallel with the first region. Specifically, the processor determines the second code region before choosing the complete flow-control path, which is to be traversed in the first code region until exiting the first code region. Once the beginning of the second code region has been determined, the processor begins retrieving instructions of the second region, and processes instructions of the first and second regions in parallel.

Typically, the processor predicts (i) the exit point from the first code region (and thus the beginning of the second code region), and (ii) the flow-control path through the second code region. Both predictions are made before choosing the complete flow-control path through the first code region.

In one example embodiment, the first code region comprises a loop having multiple possible internal flow-control paths and/or multiple possible exit points, and the second code region comprises code that is to be executed following exit from the loop. In another example embodiment, the first code region comprises a function having multiple possible internal flow-control paths and/or multiple possible return points, and the second code region comprises code that is to be executed following return from the function.

The disclosed techniques enable a processor to predict the location of, and start retrieving and processing, future instructions before the exact flow-control path of the present instructions is known. As a result, the processor is able to achieve a high degree of parallelization and a high degree of efficiency in using its processing resources.

In the present context, the term “retrieving instructions” refers, for example, to fetching instructions from external memory (from memory possibly via L1 or L2 cache), or reading decoded instructions or micro-ops from loop cache or μOP cache, or retrieving instructions or micro-ops from any other suitable location, as appropriate.

In some embodiments, the processor begins not only to retrieve instructions from the second code region, but also to rename them, before all the instructions of the first code region have been renamed. This parallelization is facilitated by a novel out-of-order renaming scheme that is described herein.

Several example processor architectures that can utilize the disclosed techniques, such as architectures using loop-caching and/or micro-op-caching, are described herein. Examples of code regions, e.g., complex loop structures, which can be parallelized using the disclosed techniques, are also described.

Additional disclosed techniques relate to branch prediction schemes that are suited for predicting the exit point from the first code region and thus the starting point of the second code region, to branch or trace prediction for the second code region, and to resolution of data dependencies between the first and second code regions.

### System Description

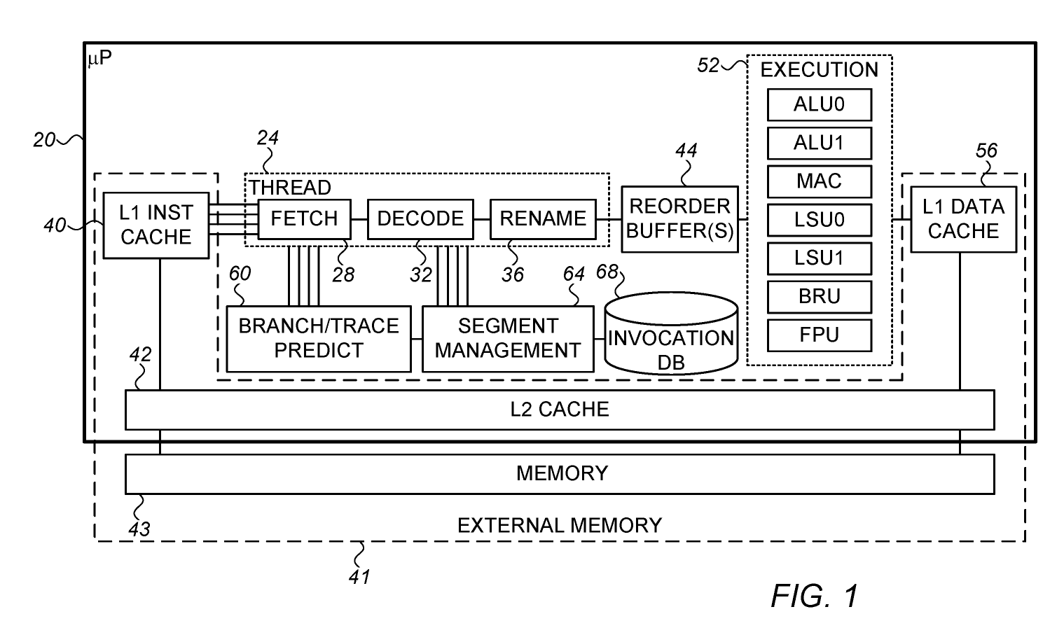

FIG. 1 is a block diagram that schematically illustrates a processor 20, in accordance with an embodiment of the present invention. In the present example, processor 20 comprises a hardware thread 24 that is configured to process multiple code regions in parallel using techniques that are described in detail below. In alternative embodiments, processor 20 may comprise multiple threads 24. Certain aspects of code parallelization are addressed, for example, in U.S. patent application Ser. Nos. 14/578,516, 14/578,518, 14/583,119, 14/637,418, 14/673,884, 14/673,889, 14/690,424, 14/794,835, 14/924,833, 14/960,385, 15/077,936, 15/196,071, 15/285,555 and 15/393,291, which are all assigned to the assignee of the present patent application and whose disclosures are incorporated herein by reference.

In the present embodiment, thread 24 comprises one or more fetching modules 28, one or more decoding modules 32 and one or more renaming modules 36 (also referred to as fetch units, decoding units and renaming units, respectively). Fetching modules 28 fetch instructions of program code from a memory, e.g., from a multi-level instruction cache. In the present example, processor 20 comprises a memory system 41 for storing instructions and data. Memory system 41 comprises a multi-level instruction cache comprising a Level-1 (L1) instruction cache 40 and a Level-2 (L2) cache 42 that cache instructions stored in a memory 43. Decoding modules 32 decode the fetched instructions.

Renaming modules 36 carry out register renaming. The decoded instructions provided by decoding modules 32 are typically specified in terms of architectural registers of the processor's Instruction Set Architecture. Processor 20 comprises a register file that comprises multiple physical registers. The renaming modules associate each architectural register in the decoded instructions to a respective physical register in the register file (typically allocates new physical registers for destination registers, and maps operands to existing physical registers).

The renamed instructions (e.g., the micro-ops/instructions output by renaming modules 36) are buffered in-order in one or more Reorder Buffers (ROB) 44, also referred to as Out-of-Order (OOO) buffers. In alternative embodiments, one or more instruction queue buffers are used instead of ROB. The buffered instructions are pending for out-of-order execution by multiple execution modules 52, i.e., not in the order in which they have been fetched. In alternative embodiments, the disclosed techniques can also be implemented in a processor that executes the instructions in-order.

The renamed instructions buffered in ROB 44 are scheduled for execution by the various execution units 52. Instruction parallelization is typically achieved by issuing one or multiple (possibly out of order) renamed instructions/micro-ops to the various execution units at the same time. In the present example, execution units 52 comprise two Arithmetic Logic Units (ALU) denoted ALU0 and ALU1, a Multiply-Accumulate (MAC) unit, two Load-Store Units (LSU) denoted LSU0 and LSU1, a Branch execution Unit (BRU) and a Floating-Point Unit (FPU). In alternative embodiments, execution units 52 may comprise any other suitable types of execution units, and/or any other suitable number of execution units of each type.

The cascaded structure of thread 24 (including fetch modules 28, decoding modules 32 and renaming modules 36), ROB 44 and execution units 52 is referred to herein as the hardware-implemented pipeline of processor 20. As noted above, in alternative embodiments the pipeline of processor 20 may comprise multiple threads 24.

The results produced by execution units 52 are saved in the register file, and/or stored in memory system 41. In some embodiments the memory system comprises a multi-level data cache that mediates between execution units 52 and memory 43. In the present example, the multi-level data cache comprises a Level-1 (L1) data cache 56 and L2 cache 42.

In some embodiments, the Load-Store Units (LSU) of processor 20 store data in memory system 41 when executing store instructions, and retrieve data from memory system when executing load instructions. The data storage and/or retrieval operations may use the data cache (e.g., L1 cache 56 and L2 cache 42) for reducing memory access latency. In some embodiments, high-level cache (e.g., L2 cache) may be implemented, for example, as separate memory areas in the same physical memory, or simply share the same memory without fixed pre-allocation.

A branch/trace prediction module 60 predicts branches or flow-control traces (multiple branches in a single prediction), referred to herein as “traces” for brevity, that are expected to be traversed by the program code during execution by the various threads 24. Based on the predictions, branch/trace prediction module 60 instructs fetching modules 28 which new instructions are to be fetched from memory. Typically, the code is divided into segments, each segment comprises a plurality of instructions, and the first instruction of a given segment is the instruction that immediately follows the last instruction of the previous segment. Branch/trace prediction in this context may predict entire paths for segments or for portions of segments, or predict the outcome of individual branch instructions.

In some embodiments, processor 20 comprises a segment management module 64. Module 64 monitors the instructions that are being processed by the pipeline of processor 20, and constructs an invocation data structure, also referred to as an invocation database 68. Invocation database 68 divides the program code into portions, and specifies the flow-control traces for these portions and the relationships between them. Module 64 uses invocation database 68 for choosing segments of instructions to be processed, and instructing the pipeline to process them. Database 68 is typically stored in a suitable internal memory of the processor.

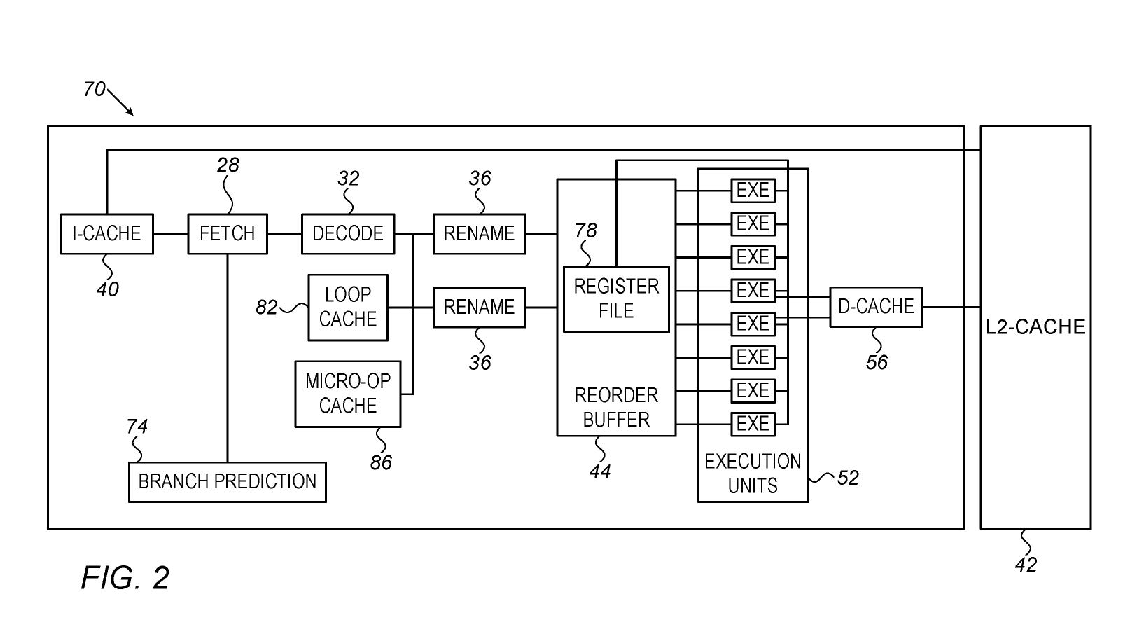

FIG. 2 is a block diagram that schematically illustrates a processor 70, in accordance with another embodiment of the present invention. Elements of processor 70 that perform similar functions to corresponding elements of processor 20 are assigned the same reference numerals as their corresponding elements.

In the example of FIG. 2, the pipeline of processor 70 comprises a branch prediction unit 74, which predicts the outcomes of conditional branch instructions. A single fetch unit 28 fetches instructions, based on the branch prediction, from instruction cache 40. A single decoding unit 32 decodes the fetched instructions, and two renaming units 36 rename the decoded instructions. The renamed instructions are buffered in ROB 44, which comprises a register file 78, and are executed by execution units 52. The results produced by execution units 52 are saved in register file 78 and/or in data cache 56.

In addition to the above-described pipeline stages, processor 70 further comprises a loop cache 82 and a micro-op (μOP) cache 86. Caches 82 and 86 enable the processor to refrain from fetching and decoding instructions in some scenarios.

For example, when processor 70 processes a program loop, after decoding the loop instructions once, the decoded instructions or micro-ops of the loop are saved in loop cache 82. In subsequent loop iterations, the processor retrieves the decoded instructions or micro-ops from cache 82, and provides the retrieved instructions/micro-ops to renaming units 36, instead of decoding the instructions again. As a result, fetch unit 28 and decoding unit 32 are free to fetch and decode other instructions, e.g., instructions from a code region that follows the loop.

As another example, when processor 70 processes a function for the first time, after decoding the instructions of the function, the decoded instructions or micro-ops of the function are saved in μOP cache 86. In subsequent calls to this function, the processor retrieves the decoded instructions or micro-ops from cache 86, and provides the retrieved instructions/micro-ops to renaming units 36, instead of decoding the instructions again. As a result, fetch unit 28 and decoding unit 32 are free to fetch and decode other instructions, e.g., instructions from a code region that follows return from the function.

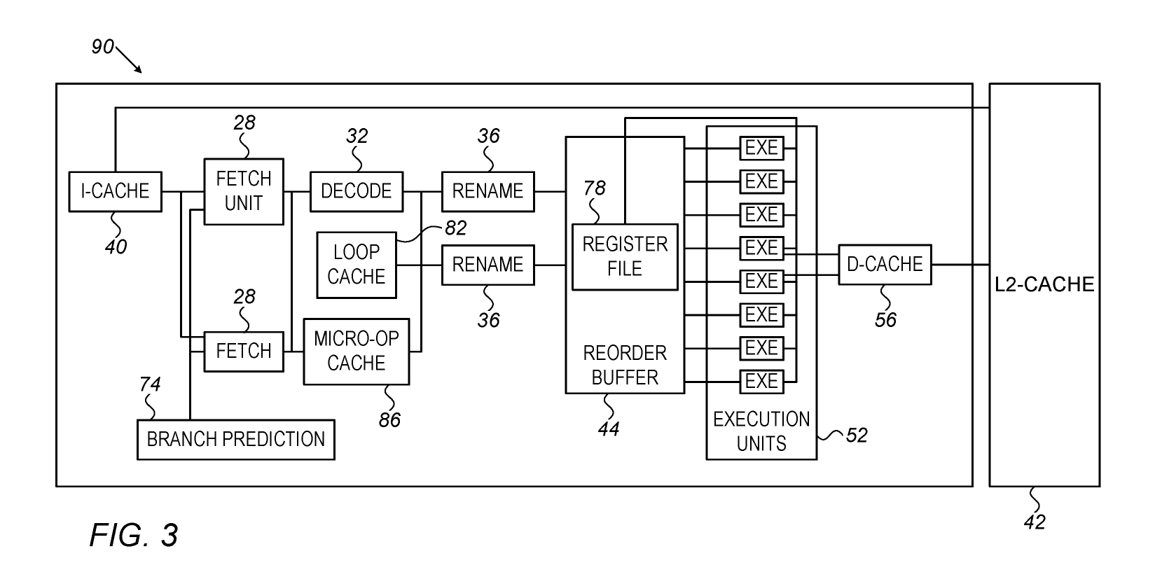

FIG. 3 is a block diagram that schematically illustrates a processor 90, in accordance with yet another embodiment of the present invention. Processor 90 is similar to processor 70 of FIG. 2, with the exception that the pipeline comprises two fetch units 28 instead of one.

The configurations of processors 20, 70 and 90 shown in FIGS. 1-3 are example configurations that are chosen purely for the sake of conceptual clarity. In alternative embodiments, any other suitable processor configuration can be used. For example, parallelization can be performed in any other suitable manner, or may be omitted altogether. The processor may be implemented without cache or with a different cache structure. The processor may comprise additional elements not shown in the figure. Further alternatively, the disclosed techniques can be carried out with processors having any other suitable microarchitecture. As another example, it is not mandatory that the processor perform register renaming.

In various embodiments, the techniques described herein may be carried out in processor 20 by module 64 using database 68, or it may be distributed between module 64, module 60 and/or other elements of the processor. Processors 70 and 90 may comprise similar segment management modules and databases (not shown in the figures). In the context of the present patent application and in the claims, any and all processor elements that control the pipeline so as to carry out the disclosed techniques are referred to collectively as “control circuitry.”

Processors 20, 70 and 90 can be implemented using any suitable hardware, such as using one or more Application-Specific Integrated Circuits (ASICs), Field-Programmable Gate Arrays (FPGAs) or other device types. Additionally or alternatively, certain processor elements can be implemented using software, or using a combination of hardware and software elements. The instruction and data cache memories can be implemented using any suitable type of memory, such as Random Access Memory (RAM).

Processors 20, 70 and 90 may be programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Retrieval and Processing of Future Code Region, Before Choosing Complete Flow Control for Present Code Region

In some embodiments of the present invention, the processor begins to process a future code region before choosing the complete exact flow control of the present code region from among the multiple possibilities. The techniques described below can be carried out by any suitable processor configuration, e.g., using processor 20 of FIG. 1, processor 70 of FIG. 2 or processor 90 of FIG. 3.

Consider, for example, a loop (“first region” in this example) having multiple possible internal flow-control paths, and/or multiple possible exit points. In some embodiments, the processor pipeline processes the instructions of the loop at a certain point in time. While processing the loop, the control circuitry of the processor predicts the region of the code that will be processed following the loop (“second region” in this example). This prediction is made before the actual full flow control path in the loop is selected (e.g., before determining the actual number of loop iterations and/or before determining the exact flow control of at least one of the iterations). It is noted that the term “program loop” refers in a broad sense to a wide variety of instruction sequences exhibiting some repetitive nature. In the compiled code (in assembler), a loop may have various complex structures.

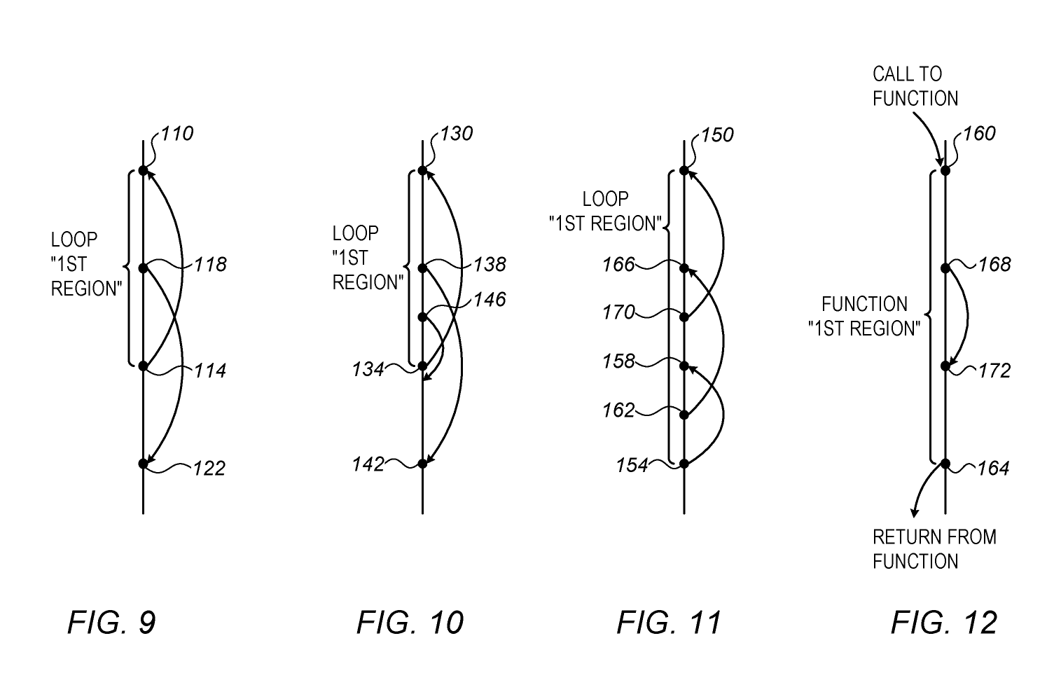

In the present context, the term “complete flow-control path through the first region” means a flow-control path from entry into the first region until exiting the first region (but not necessarily traversing all the instructions in the first region). In the present context, performing different numbers of iterations of a loop is regarded as traversing different flow-control paths. FIGS. 9-11 below illustrate several examples of such loops.

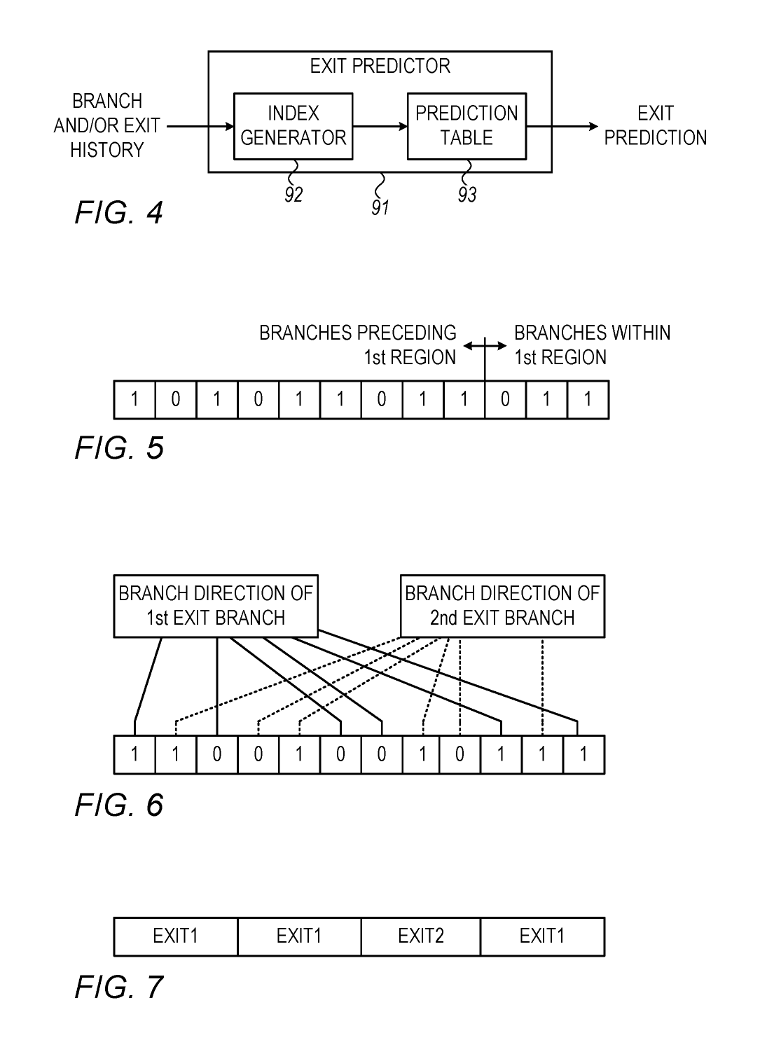

FIG. 4 is a block diagram that schematically illustrates an exit predictor 91, which is configured to predict the exit point from the first code region, and thus also predict the beginning of the second code region, in accordance with an embodiment of the present invention. This configuration can be used, for example, for implementing branch/trace prediction module 60 of FIG. 1, and/or branch prediction module 74 of FIGS. 2 and 3.

In the present example, exit predictor 91 comprises an index generator 92 and a prediction table 93. Index generator 92 receives branch history or exit history as input. The branch history may comprise any suitable information on actual branch decisions (“branch taken” or “branch not taken”) of branch instructions that were previously encountered in processing of the program code, and/or prediction history of branches. Several examples of branch history are described further below. Index generator 92 generates an index to prediction table 93, based on the branch history.

Typically, although not necessarily, the index generator applies a suitable hash function to the branch history, so as to produce the index. The hash function typically depends on the Program Counter (PC) value of the branch instruction whose outcome is being predicted. Prediction table 93 stores a predicted exit point from the first region per index value. Thus, branch predictor 91 generates predicted exit points from the first region, based on the branch history.

As noted above, the processor's control circuitry (e.g., branch/trace prediction module 60 of FIG. 1, or branch prediction module 74 of FIGS. 2 and 3) predicts the beginning of the second region (e.g., the PC value of the first instruction in the second region). The prediction is typically performed based on past branch decisions (e.g., “branch taken” vs. “branch not taken”) decided in one or more conditional branch instructions in the first region.

A naïve solution might base the prediction on global branch prediction (e.g., on the N most recent branch decisions made in the first region). In contrast to such naïve solutions, in some embodiments of the present invention, the control circuitry (e.g., branch/trace prediction module 60 or branch prediction module 74) predicts the location of the second region based only on branch instructions that (in at least one of their possible branch decisions) exit the first region.

In alternative embodiments, the control circuitry may predict the exit point from the first region, and thus the location of the second region, based on any suitable set of (one or more) branch decisions of any suitable set of (one or more) branch instructions having a branch decision that exits the first region.

FIG. 5 is a diagram that schematically illustrates an example branch history that can be used as input to exit predictor 91 of FIG. 4, in accordance with an embodiment of the present invention. In the present example, the branch history comprises the sequence of N most recent branch decisions. Without loss of generality, “0” represents “not taken” and “1” represents “taken”.

In the present example, some of the past branch decisions in the branch history pertain to branch instructions that precede the first region (i.e., lead to the first region), and some of the past branch decisions in the branch history pertain to branch instructions within the first region. In other embodiments, the branch history may comprise only past branch decisions of branch instructions that precede the first region (i.e., lead to the first region). In yet other embodiments, the branch history may comprise only past branch decisions of branch instructions that are within the first region.

FIG. 6 is a diagram that schematically illustrates another example branch history that can be used as input to exit predictor 91, in accordance with an embodiment of the present invention. In this embodiment, the branch history comprises only branch decisions/predictions of branch instructions that potentially (i.e., in at least one of the two possible branch decisions) exit the first region. Branch instructions that do not cause exit from the first region are excluded. In the present example, the first region can be exit via two possible branch instructions, referred to as “BRANCH #1” and “BRANCH #2”.

This sort of history is also referred to herein as “exit history.” It should be noted, however, that some of the branch decisions in this branch history may not in fact exit the first region. Consider, for example, a branch instruction that causes the flow-control to exit the first region if taken, but to remain inside the first region if not taken. The branch history of FIG. 6 may include both historical “taken” and “not-taken” decisions of this instruction.

FIG. 7 is a diagram that schematically illustrates another example “exit history” that can be used as input to exit predictor 91, in accordance with an embodiment of the present invention. In this example, the branch history records the pattern of past exit points from the first region. In the present context, the term “exit point from the first region” means a branch instruction having at least one branch decision that causes the flow-control to exit the first region. In the example of FIG. 7, the most recent exit from the first region was via BRANCH #1 (marked “EXIT1”), the previous exit from the first region was via BRANCH #2 (marked “EXIT2”), and the two previous exits were again via BRANCH #1 (again marked “EXIT1”). The exits in this example may refer to exits from the first region (“local”) or to exits from various regions (“global”).

In one example embodiment, the control circuitry predicts the exit point from the first region, and thus the location of the beginning of the second region, based on the most recent branch decision that previously caused exit from the first region. This criterion predicts that the second region following the present traversal of the first region will be the same as in the previous traversal of the first region

The examples above referred to scenarios in which the “first region” is a loop. Another example scenario is a function (“first region” in this example) having multiple possible internal flow-control paths. While processing the instructions of the function, and before choosing the exact flow control through the function, the control circuitry predicts the region of code (“second region” in this example) that will be reached upon returning from the function. Typically, and although multiple return points from a function may exist, the (second) region after the function would typically be directly (sequentially) after the call to the function and thus can be easily predicted. FIG. 12 below illustrates an example of such a function.

Further alternatively, the disclosed technique can be applied to any other suitable regions of code, not necessarily loops and functions. Additionally or alternatively to the techniques described above, the control circuitry may predict the exit point from the first code region based on one or more hints embedded in the software code. For example, the code may comprise a dedicated instruction in which the compiler or the software specifies the program-counter value of the beginning of the second code region.

In some embodiments, the control circuitry predicts the start of the second region using branch prediction techniques, e.g., using a hardware configuration similar to that of branch/trace prediction module 60 of FIG. 1, or branch prediction module 74 of FIGS. 2 and 3. In contrast to naïve local or global branch prediction, however, the disclosed branch prediction schemes may ignore selected parts of the branch history, e.g., ignore branch instructions that do not cause exit from the first region.

In various embodiments, the control circuitry may select the point in time in which to consider the history of past branch decisions for predicting the location of the second region (i.e., the exit point from the first region). In one embodiment, the control circuitry considers the history of past branch decisions that is known at the time the pipeline is ready to start retrieving the instructions of the second region.

Typically, in order to retrieve instructions from the second region, the control circuitry predicts the flow-control path that will be traversed through the second region. This prediction may be performed using a hardware configuration similar to that of FIG. 4 above (but with the index generator receiving trace history as input instead of branch history, and the prediction table generating predicted trace names instead of exit predictions).

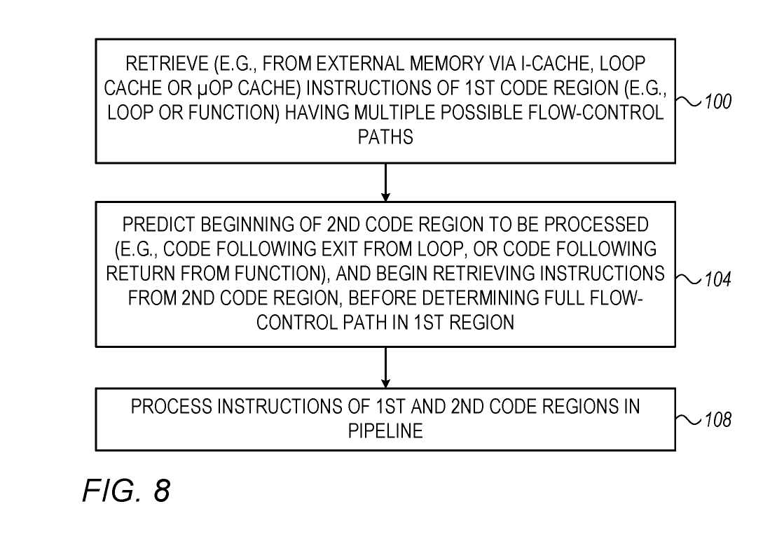

FIG. 8 is a flow chart that schematically illustrates a method for processing of multiple code regions, in accordance with an embodiment of the present invention. The method begins with the processor's control circuitry (e.g., branch prediction module) instructing the pipeline to retrieve and process instructions of the first code region, at a first retrieval step 100.

In the present context, the term “retrieving instructions” refers, for example, to fetching instructions from external memory (from memory 43 possibly via L1 I-cache 40 or L2 cache 42), or reading decoded instructions or micro-ops from loop cache 82 or μOP cache 86, or retrieving instructions or micro-ops from any other suitable location, as appropriate.

At a prediction step 104, the control circuitry (e.g., branch/trace prediction module 60 or branch prediction module 74) predicts the beginning of the second code region. In the present context, the term “predicting a second code region” means predicting the start PC value of the second region. The prediction is made before the complete actual flow control through the first region has been chosen. Having predicted the second region, the control circuitry instructs the pipeline to begin retrieving and processing instructions of the second code region. This retrieval, too, may be performed from external memory, loop cache or μOP cache, for example.

At a processing step 108, the control circuitry instructs the pipeline to process the instructions of the first and second code regions in parallel. When processing the instructions of the first and second code regions in parallel, the control circuitry may handle dependencies between the first and second regions using any suitable technique. Some example techniques are described in the co-assigned patent applications cite above.

In some embodiments, decoding unit 32 decodes only instructions of one code region at most (either the first region or the second region, but not both) in a given clock cycle. In some cases, when using a loop cache and/or μOP cache, the decoding unit may be idle in a given clock cycle, while retrieval of instructions is performed from the loop cache and/or μOP cache. In one example scenario, instructions for the first code region are retrieved from loop cache 82, and instructions for the second code region (code following exit from the loop) are retrieved from μOP cache 86 in the same cycle. The decoding unit may be idle during this time, or it may decode instructions of yet another code region. Finally, in some cases instructions for both code regions are retrieved from a multi-port μOP cache in a given cycle (not necessarily in all cycles}.

FIGS. 9-12 are diagrams that schematically illustrate examples of code regions that can be processed using the disclosed techniques, in accordance with embodiments of the present invention. The vertical axis in the figures refers to the order of instructions in the code, in ascending order of Program Counter (PC) values, from top to bottom.

FIG. 9 shows an example of a loop having two possible exit points. The loop (“first region”) lies between an instruction 110 and a branch instruction 114. Thus, one exit point from the loop is at branch instruction 114 (in case this conditional branch is not taken), after completing the chosen number of loop iterations. A conditional branch instruction 118 inside the loop creates a second possible exit point from the loop, jumping to an instruction 122.

In this example, the loop has multiple possible flow-control paths that may be traversed (different possible numbers of loop iterations, and different exit points). The actual flow-control path in a particular run may be data dependent. Depending on the exit point from the loop, the code region reached after exiting the loop (“second region”) may begin at the instruction following instruction 114, or at the instruction following instruction 122.

In some embodiments, the control circuitry predicts which exit point is going to be used. Based on this prediction, the control circuitry instructs the pipeline whether to start retrieving instructions of the code region following instruction 114, or of the code region following instruction 122.

As can be appreciated, this prediction is statistical and not guaranteed to succeed. If the prediction fails, e.g., a different exit point is actually chosen, the control circuitry may flush the instructions of the second region from the pipeline. In this scenario, the pipeline is populated with a mix of instructions, some belonging to the first region and others belonging to the second region. Nevertheless, the control circuitry flushes only the instruction belonging to the second region. Example techniques for performing such selecting flushing are described, for example, in U.S. patent application Ser. No. 15/285,555, cited above.

FIG. 10 shows another example of a loop having multiple possible exit points. The loop (“first region”) lies between an instruction 130 and a branch instruction 134. Thus, one possible exit point is instruction 134. A conditional branch instruction 138 inside the loop creates another possible exit point from the loop, jumping to an instruction 142. Another conditional branch instruction 146 conditionally jumps to the instruction that follows instruction 134, thus creating additional possible flow-control paths within the loop. Thus, depending on the actual flow-control chosen, the “second region” may begin at the instruction following instruction 134, or at the instruction following instruction 142.

FIG. 11 shows yet another example of a loop having multiple flow control possibilities. The loop (“first region”) lies between an instruction 150 and a branch instruction 154. In this example, instruction 154 is the only possible exit point from the loop. Inside the loop, however, multiple flow-control paths are possible, e.g., jumping from instruction 154 to an instruction 158, from an instruction 162 to an instruction 166, or from an instruction 170 to instruction 150.

FIG. 12 shows an example of a function having multiple possible internal flow-control paths. The function (“first region”) lies between an instruction 160 and a return instruction 164. Inside the function, two flow-control paths are possible. A first flow-control path traverses all the instructions of the function sequentially, until exiting the function and returning at instruction 164. A second flow-control path diverges at a conditional branch instruction 168, skips the instructions until an instruction 172, and finally exits the function and returns at instruction 164.

In all of these examples of code, and in any other suitable example, the disclosed technique enables the processor to predict the start of the “second region” before the actual complete flow control through the “first region” has been fully chosen, and thus to process the two regions in parallel in the pipeline.

### Instruction Renaming Considerations

The instructions processed by the pipeline are typically specified in terms of one or more architectural registers defined in the Instruction Set Architecture of the processor. Each renaming unit 36 in the pipeline renames the registers in the instructions, i.e., maps the architectural registers to physical registers of the processor. In some non-limiting embodiments, at any given time renaming unit 36 maintains and updates an architectural-to-physical register mapping, referred to herein as “register map.”

Renaming unit 36 uses the register map for translating logical registers in the instructions/micro-ops into physical registers. Typically, the renaming unit uses the register map to map operand registers (architectural registers that are read from) to the appropriate physical registers from which the operands should be read. For each instruction that updates an architectural register, a new physical register is allocated as a destination register. The new allocations are updated in the register map, for use when these architectural registers are next used as operands. The renaming unit updates the register map continuously during processing, i.e., allocates physical registers to destination architectural registers updates the register map accordingly.

When using the disclosed techniques, however, the pipeline starts processing the instructions of the “second region” before the register mapping for the exit from the “first region” is known. Nevertheless, in some embodiments, the processor is able to start renaming the instructions of the second region before all the instructions of the first region have been renamed.

In some embodiments, while the renaming unit is renaming instructions of the first region, the control circuitry predicts the register map that is expected to be produced by the renaming unit upon exit from the first region. This register map is referred to herein as the “speculative final register map” of the first region. From the speculative final register map of the first region, the control circuitry derives a speculative initial register map for the second region. The renaming unit (or another renaming unit) begins to rename instructions of the second region using the speculative initial map. In this manner, renaming of instructions of the second region begins long before the instructions of the first region are fully renamed, i.e., the two regions are renamed at least partially in parallel.

Further aspects of such out-of-order renaming are addressed in U.S. Pat. No. 9,430,244, entitled “Run-Time Code Parallelization using Out-Of-Order Renaming with Pre-Allocation of Physical Registers,” whose disclosure is incorporated herein by reference.

In some embodiments, the control circuitry monitors the various possible flow-control paths in the first region, and studies the overall possible register behavior of the different control-flow paths. Based on this information, the control circuitry learns which registers will be written-to. The control circuitry then creates a partial final register map for the first region. In an example implementation, the control circuitry adds at the end of the first region micro-ops that transfer the values of the logical registers that were written-to into physical registers that were pre-allocated in the second region. These additional micro-ops are only issued when the relevant registers are valid for readout, e.g., after all branches are resolved. Alternatively, the additional micro-ops may be issued earlier, and the second region may be flushed in case these micro-ops are flushed.

In an embodiment, the control circuitry dispatches to the reorder buffer at least one of the instructions of the second region before all the instructions of the first region have been renamed by the pipeline.

### Branch/Trace Prediction for the Second Region

In some embodiments, upon predicting the start location of the second code region, the control circuitry predicts the flow-control path that will be traversed inside the second region. This prediction is used for instructing the pipeline to retrieve the instructions of the second region. The control circuitry may apply branch prediction (prediction of branch decisions of individual branch instructions) or trace prediction (prediction of branch decisions of entire paths that comprise multiple branch instructions) for this purpose. As noted above, prediction of the flow-control path inside the second region begins before the flow-control path in the first region is fully known.

In one embodiment, the control circuitry predicts the flow control in the second region (using branch prediction or trace prediction) based on the history of past branch decisions that is known at the time the pipeline is ready to start retrieving the instructions of the second region. This criterion takes into account branch decisions made in the first region.

In an alternative embodiment, the control circuitry predicts the flow control in the second region (using branch prediction or trace prediction) based only on past branch decisions of branch instructions that precede the first region (i.e., that lead to the first region). This criterion effectively disregards the flow control in the first region, and considers only the flow control that preceded the first region.

Further alternatively, the control circuitry may predict the flow control in the second region (before the flow-control path in the first region is fully known) based on any other suitable selection of past branch decisions. As described above, some of these past branch decisions may comprise historical exits from the first code region. Some of these past branch decisions may comprise historical exits from one or more other code regions, e.g., exits from the code that precedes the first region, leading to the first code region.

### Resolution of Dependencies Between the First and Second Regions

In many practical scenarios, at least some of the instructions in the second region depend on actual data values (e.g., register values or values of memory addresses) determined in the first region, and/or on the actual flow control chosen in the first region.

In some embodiments, the control circuitry may instruct the pipeline to process such instructions in the second region speculatively, based on predicted data values and/or predicted flow control. In these embodiments, mis-prediction of data and/or control flow may cause flushing of instructions, thereby degrading efficiency.

In alternative embodiments, the control circuitry sets certain constraints on the parallelization of the first and second regions, in order to eliminate or reduce the likelihood of mis-prediction.

For example, as long as one or more conditional branches in the first region are still unresolved, the control circuitry may allow the pipeline to execute only instructions in the second region that do not depend on any register value set in the first region. In other words, execution of instructions in the second region, which depend on register values set in the first region, are deferred until all conditional branches in the first region are resolved (executed).

Additionally or alternatively, in order to execute an instruction in the second region, which depends on a register value set in the first region, the control circuitry may predict the value of this register and execute the instruction in question using the predicted register value. In this manner, the instruction in question can be executed (speculatively) before all conditional branches in the first region are resolved (executed). If the register value prediction is later found wrong, at least some of the instructions of the second region may need to be flushed.

Further alternatively, the control circuitry may allow some instructions to be processed speculatively based on value prediction, and for other instructions wait for the dependencies to be resolved. Such hybrid schemes allow for various performance trade-offs.

As another example, consider an instruction in the second region (referred to as “second instruction”) that depends on a data value (register value or value of a memory address) that is produced by an instruction in the first region (referred to as “first instruction”). In some embodiments, the control circuitry makes the data value available to the execution unit that executes the second instruction, only when this data value is valid for readout by instructions in the second region. In the present context, the term “valid for readout” means that the data value will not change during processing of subsequent instructions in the first region.

The control circuitry may use various methods and criteria for verifying that a data value produced in the first region is valid for readout by instructions in the second region. For example, the control circuitry may verify that all conditional branch instructions in the first region, which precede the last write of this data value, have been resolved. In another embodiment, for a register value, the control circuitry may verify that the last write to this register in the first region has been committed. The control circuitry may identify the last write of a certain data value, for example, by monitoring the processing of instructions of the first region.

The processing circuitry may use any suitable technique for making data values, produced by instructions in the first region, available to instructions in the second regions. For example, the control circuitry may inject into the pipeline one or more micro-ops that transfer the data values. Further aspects of transferring data values, e.g., when they become ready for readout are addressed in U.S. patent application Ser. No. 14/690,424, cited above.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
retrieving to a pipeline of a processor first instructions of program code from a first region in the program code;
before fully determining a flow-control path, which is to be traversed within the first region until exit from the first region, predicting a beginning of a second region in the code that is to be processed following the first region and beginning to retrieve to the pipeline second instructions from the second region; and
processing the retrieved first instructions and second instructions by the pipeline.

2. The method according to claim 1, wherein processing the first instructions and the second instructions comprises renaming at least one of the second instructions before all the first instructions have been renamed by the pipeline.

3. The method according to claim 2, wherein processing the first instructions and the second instructions comprises dispatching to a reorder buffer at least one of the second instructions before all the first instructions have been renamed by the pipeline.

4. The method according to claim 2, wherein processing the first instructions and the second instructions comprises defining an initial architectural-to-physical register mapping for the second region before all architectural registers appearing in the first instructions have been mapped to physical registers.

5. The method according to claim 1, wherein the first instructions belong to a program loop, and wherein the second instructions belong to a code segment subsequent to the program loop.

6. The method according to claim 1, wherein the first instructions belong to a function, and wherein the second instructions belong to a code segment subsequent to returning from the function.

7. The method according to claim 1, wherein retrieving the first instructions and the second instructions comprises fetching at least one instruction from a memory or cache.

8. The method according to claim 1, wherein retrieving the first instructions and the second instructions comprises reading at least one decoded instruction or micro-op from a cache that caches previously-decoded instructions or micro-ops.

9. The method according to claim 1, wherein prediction of the beginning of the second region is based on a history of past branch decisions of one or more instructions that conditionally exit the first region.

10. The method according to claim 1, wherein prediction of the beginning of the second region is independent of past branch decisions of branch instructions that do not exit the first region.

11. The method according to claim 1, wherein prediction of the beginning of the second region is independent of past branch decisions of branch instructions that are in the first region.

12. The method according to claim 1, wherein prediction of the beginning of the second region is based on historical exits from the first region, or from one or more other regions.

13. The method according to claim 1, wherein prediction of the beginning of the second region is based on one or more hints embedded in the program code.

14. The method according to claim 1, further comprising predicting a flow control in the second region based on one or more past branch decisions of one or more instructions in the first region.

15. The method according to claim 1, further comprising predicting a flow control in the second region based on one or more past branch decisions of one or more instructions that precede the first region.

16. The method according to claim 15, wherein prediction of the flow control in the second region is independent of past branch decisions of branch instructions that are in the first region.

17. The method according to claim 1, further comprising predicting a flow control in the second region based on an exit point from the first region.

18. The method according to claim 1, wherein processing the first instructions and the second instructions comprises, as long as one or more conditional branches in the first region are unresolved, executing only second instructions that do not depend on any register value set in the first region.

19. The method according to claim 1, wherein processing the first instructions and the second instructions comprises, while one or more conditional branches in the first region are unresolved, executing one or more of the second instructions that depend on a register value set in the first region, based on a prediction of the register value set in the first region.

20. The method according to claim 1, wherein processing the first instructions and the second instructions comprises making a data value, which is produced by the first instructions, available to the second instructions only in response to verifying that the data value is valid for readout by the second instructions.

21. A processor, comprising:
a hardware-implemented pipeline; and
control circuitry, which is configured to:
instruct the pipeline to retrieve first instructions of program code from a first region in the program code; and
before fully determining a flow-control path, which is to be traversed within the first region until exit from the first region, to predict a beginning of a second region in the code that is to be processed following the first region and instruct the pipeline to begin retrieving second instructions from the second region, so as to cause the pipeline to process the retrieved first instructions and second instructions.

22. The processor according to claim 21, wherein the control circuitry is configured to instruct the pipeline rename at least one of the second instructions before all the first instructions have been renamed by the pipeline.

23. The processor according to claim 22, wherein the control circuitry is configured to dispatch to a reorder buffer at least one of the second instructions before all the first instructions have been renamed by the pipeline.

24. The processor according to claim 22, wherein the control circuitry is configured to define an initial architectural-to-physical register mapping for the second region before all architectural registers appearing in the first instructions have been mapped to physical registers.

25. The processor according to claim 21, wherein the first instructions belong to a program loop, and wherein the second instructions belong to a code segment subsequent to the program loop.

26. The processor according to claim 21, wherein the first instructions belong to a function, and wherein the second instructions belong to a code segment subsequent to returning from the function.

27. The processor according to claim 21, wherein the control circuitry is configured to retrieve the first instructions and the second instructions by fetching at least one instruction from a memory or cache.

28. The processor according to claim 21, wherein the control circuitry is configured to retrieve the first instructions and the second instructions by reading at least one decoded instruction or micro-op from a cache that caches previously-decoded instructions or micro-ops.

29. The processor according to claim 21, wherein the control circuitry is configured to predict the beginning of the second region based on a history of past branch decisions of one or more instructions that conditionally exit the first region.

30. The processor according to claim 21, wherein the control circuitry is configured to predict the beginning of the second region independently of past branch decisions of branch instructions that do not exit the first region.

31. The processor according to claim 21, wherein the control circuitry is configured to predict the beginning of the second region independently of past branch decisions of branch instructions that are in the first region.

32. The processor according to claim 21, wherein the control circuitry is configured to predict the beginning of the second region based on historical exits from the first region, or from one or more other regions.

33. The processor according to claim 21, wherein the control circuitry is configured to predict the beginning of the second region based on one or more hints embedded in the program code.

34. The processor according to claim 21, wherein the control circuitry is further configured to predict a flow control in the second region based on one or more past branch decisions of one or more instructions in the first region.

35. The processor according to claim 21, wherein the control circuitry is further configured to predict a flow control in the second region based on one or more past branch decisions of one or more instructions that precede the first region.

36. The processor according to claim 35, wherein the control circuitry is configured to predict the flow control in the second region independently of past branch decisions of branch instructions that are in the first region.

37. The processor according to claim 21, wherein the control circuitry is further configured to predict a flow control in the second region based on an exit point from the first region.

38. The processor according to claim 21, wherein, as long as one or more conditional branches in the first region are unresolved, the control circuitry is configured to instruct the pipeline to execute only second instructions that do not depend on any register value set in the first region.

39. The processor according to claim 21, wherein, while one or more conditional branches in the first region are unresolved, the control circuitry is configured to instruct the pipeline to execute one or more of the second instructions that depend on a register value set in the first region, based on a prediction of the register value set in the first region.

40. The processor according to claim 21, wherein the control circuitry is configured to make a data value, which is produced by the first instructions, available to the second instructions only in response to verifying that the data value is valid for readout by the second instructions.
